(19) United States
(12) Patent Application Publication
(10) Pub. No.: US 2009/0144311 A1
(43) Pub. Date: Jun. 4, 2009

(54) METHOD AND APPARATUS FOR DEVELOPING HIGH RESOLUTION DATABASES FROM LOW RESOLUTION DATABASES

(75) Inventors: GLAFKOS STRATIS, LAKE WORTH, FL (US); ALEXANDER BIJAMOV, PLANTATION, FL (US); CELESTINO CORRAL, OCALA, FL (US); SALVADOR SIBECAS, LAKE WORTH, FL (US); BRIAN SWENEY, CHICAGO, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/948,714

(22) Filed: Nov. 30, 2007

(51) Int. Cl. G06F 17/30

(52) U.S. Cl. 707/102; 707/E17.001

(57) ABSTRACT

A method (10) and system (200) for generating a high resolution database from low resolution databases introduces (12) a low resolution database and selects a desired area, classifies (16) portions of the desired area and geographically locates and generates (20) a new desired area based on a higher resolution setting than is found on the low resolution database. The method can further incorporate (22) the portions of the desired area that were geographically located in the new desired area and replaces (24) the portions of the desired area that were geographically located with a higher resolution object. The method can define (14) the low resolution database and identify (18) the higher resolution setting. The method can also save (26) a composite resolution database. The method can use an aerial image and its pixilation to create a higher resolution image by interpolation to form a higher resolution image.

### FIELD

This invention relates generally to creating high resolution databases, and more particularly to creating and using high resolution databases for simulating wireless communication systems.

### BACKGROUND

Terrain or building databases play a vital role in system deployment and optimization. Most of the deployment tools today are using low resolution databases due to cost considerations. Lately though, due to seamless mobility considerations and the deployment of WiMax and other similar communication systems, there is a drive towards deployment or simulation tools that use high resolution. Many companies lose contracts due to the fact that they perform only low resolution simulations and mostly because they don't have high resolution databases.

High resolution databases (e.g., databases having a resolution of around 1 meter) are very expensive and the high cost of high resolution databases discourages many companies from executing detailed simulations. A second problem is that even where high resolution databases exist, the databases include objects that come in the form of hollow rectangular boxes or other non-descript forms which make the simulations useless because they appear very unrealistic. A third problem is that high resolution data is not available everywhere especially in the foreign countries.

### SUMMARY

Embodiments in accordance with the present invention can provide a method and system for generating high resolution databases from low resolution databases. Embodiments herein can make use of mixed resolution having access to both low resolution and high resolution data. From a simulation approach, embodiments herein can include for example buildings (having high resolution) and also investigate the indoor/outdoor coverage as well.

In a first embodiment of the present invention, a method for generating high resolution building databases from low resolution databases can include the steps of introducing a low resolution database, selecting a desired area using the low resolution database, classifying portions of the desired area and a corresponding geo-location of objects, geographically locating the portions of the desired area and generating a new desired area of higher resolution setting than is found on the low resolution database. The method can further incorporate the portions of the desired area that were geographically located in the new desired area and replace the portions of the desired area that were geographically located with a higher resolution object. The method can further include the steps of defining the low resolution database and identifying the higher resolution setting. The method can further save a composite mixed resolution database and maintain scale when replacing from low resolution to higher resolution. The step of classifying portions can involve classifying various classes of buildings within the desired area. The step of geographically locating the portions of the desired area can involve geo-locating each building within the desired area. The method can further include taking an aerial image and using pixilation of the aerial image to create a higher resolution image by interpolation of one pixel to multiple pixels to form a higher resolution image. The method can further use a database of existing buildings and structures to enhance a low resolution image to provide a higher resolution portion for purposes of radio frequency simulation. In one embodiment, the method can superimpose higher resolution data onto a lower resolution data image.

In a second embodiment of the present invention, a computer program can be embodied in a computer storage medium and operable in a data processing system for generating high resolution building databases from low resolution databases. The data processing system can further be operable to function as otherwise previously described with the first embodiment described above.

In a third embodiment in accordance with an embodiment of the present invention, a method for generating high resolution building databases from low resolution databases can include the steps of introducing a low resolution database and defining the resolution of the low resolution database, selecting a desired area using the low resolution database, classifying portions of the desired area by classifying various classes or types of buildings within the desired area, identifying a higher resolution setting, geographically locating the portions of the desired area, and generating a new desired area based on the higher resolution setting than is found on the low resolution database. The method can further incorporate the portions of the desired area that were geographically located in the new desired area and replace the portions of the desired area that were geographically located with a higher resolution object. The method can further save a composite mixed resolution database. The step of geographically locating the portions of the desired area can include geo-locating each building within the desired area. In one embodiment, the method can further include the step of taking an aerial image and using pixilation of the aerial image to create a higher resolution image by interpolation of one pixel to multiple pixels to form a higher resolution image.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “low resolution” as used herein can mean any resolution data that is less than higher resolution data and “higher resolution” data can mean any resolution that is higher than the low resolution data in a relative sense. For example, clutter data commonly used for large rural areas and suburban areas would be considered lower resolution data in contrast to the higher resolution data that is typically found in maps for urban areas using Google Maps for example. A “desired area” would be an area of interest to the user generally and can indicate an area including buildings or other objects, but is not necessarily limited in this regard. “Geo-location” or “geographically locating” can mean defining a geographic location generally and can be defined in terms of latitude and longitude and optionally altitude although other ways of geo-location are certainly contemplated. For example, a location can also be defined in relative terms to an existing known location using distance and direction. “Enhancing” a low resolution image can mean providing a higher resolution image overall by mixing, combining, overlaying, or superimposing a higher resolution image portion on or with the low resolution image.

The terms “program,” “software application” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart illustrating a method for generating high resolution databases from low resolution databases in accordance with an embodiment of the present invention.

FIG. 2 is an illustration of how imported data from a building library or a high resolution database can be incorporated or superimposed onto a low resolution database or image in accordance with an embodiment of the present invention.

FIG. 3 is another illustration of how imported data having higher resolution can be combined, incorporated or superimposed onto a low resolution database or image in accordance with an embodiment of the present invention.

FIG. 4 is a wireless device that can be deployed in an area being simulated in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a variety of methods that can be incorporated for example into a shoot and bounce ray (SBR) simulation tool that provides for simulation of RF sources within a predetermined environment. The environments can be outside as well as within the building(s). One issue that has existed is the ability to economically simulate building environments on a large scale deployment. One embodiment can use aerial or other images and further use the pixilation of the low resolution image to create an overall higher resolution image by the interpolation of the one pixel to multiple pixels in the higher resolution image. A database of existing buildings and structures can also serve as a way to further enhance the conversion of the image for the purpose of RF simulation.

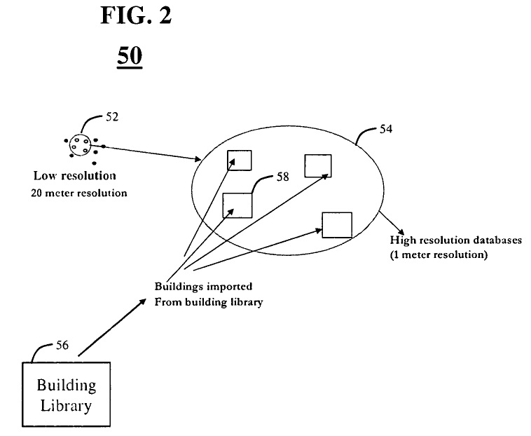

Embodiments herein can use low cost low resolution data bases (20 meter resolution) where the low resolution buildings usually appear like dots in a real picture and in pixel format. Using the low resolution format and the techniques herein, a higher resolution database (in other formats available from Google and elsewhere) can be developed which provides for more realistic images than are available from the vendors of such data bases (hollow boxes). For example, referring to FIG. 2, in a 20 meter resolution database, buildings appear as dots as shown in area 52 of the image 50. These dots (or pixels) have a certain spacing, dimensions and geo-location (i.e., longitude and latitude) with respect to each other on that particular area 52. Buildings or structural features 58 from a building library 56, for example, can be used to enhance the low resolution image or database by incorporating higher resolution data for the buildings into the low resolution database or image to form a composite image or database 54.

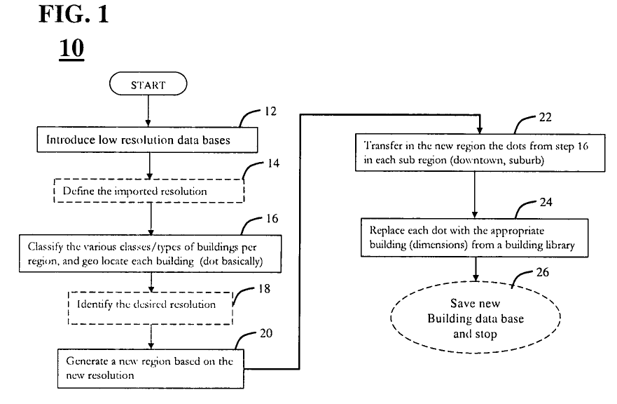

Referring to the flow chart and method 10 of FIG. 1 for generating a high resolution database from low resolution databases can include the step 12 of introducing a low resolution database, selecting a desired area using the low resolution database, classifying portions of the desired area and geographically locating the portions of the desired area at step 16 and generating at step 20 a new desired area based on a higher resolution setting than is found on the low resolution database. The method 10 can further incorporate at step 22 the portions of the desired area that were geographically located in the new desired area and replace the portions of the desired area that were geographically located with a higher resolution object at step 24. The method 10 can further include the steps of defining the low resolution database at step 14 and identifying the higher resolution setting at step 18. The method 10 can further save a composite mixed resolution database at step 26. The step of classifying portions can involve classifying various classes of buildings within the desired area. An example of classifying portions of the desired area by classifying various classes or types of buildings within a desired area can involving knowing specific or estimated dimensions such as low rise or high rise building classifications. It can also involve knowing about the materials the buildings are comprised or their geometric shape. The step of geographically locating the portions of the desired area can involve geo-locating each building within the desired area. The method can further include taking an aerial image and using pixilation of the aerial image to create a higher resolution image by interpolation of one pixel to multiple pixels to form a higher resolution image.

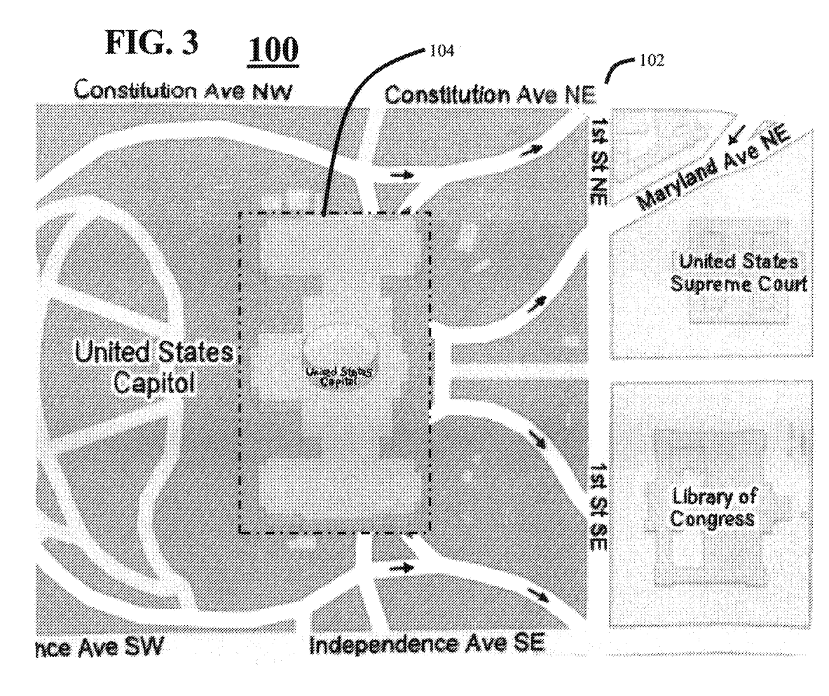

Referring to FIG. 3, the method can further use a database of existing buildings and structures (104) to enhance a low resolution image 102 to provide an overall higher resolution portion 100 for purposes of radio frequency simulation. In one embodiment, the method can superimpose higher resolution data (104) onto a lower resolution data image (102). The higher resolution data can be three dimensional (3-D) data that can provide fairly accurate data as to the footprint of the building or object and further provide an indication of the height of the building or object and the low resolution data can be clutter data.

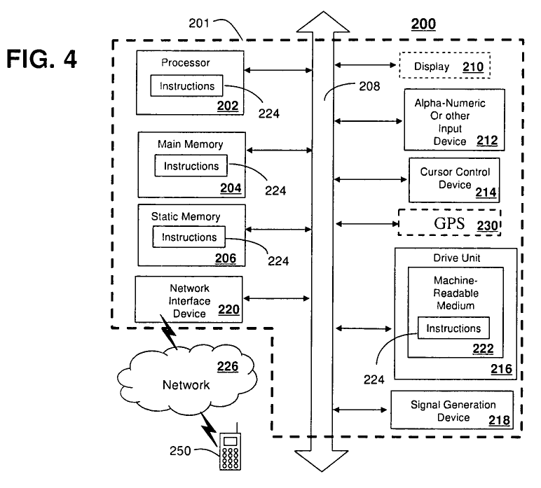

In another embodiment of the present invention as illustrated in the diagrammatic representation of FIG. 4, is a computer system 200 or electronic product 201 that can include a processor or controller 202 coupled to an optional display 210. The electronic product 201 can selectively be a wrist-worn device or a hand-held device or a fixed device. Generally, in various embodiments it can be thought of as a machine in the form of a computer system 200 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa. The computer system can further include a location finding device such as a GPS receiver 230.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such the display 210. The computer system 200 may include an input device 212 (e.g., a keyboard, microphone, etc.), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor or controller 202 during execution thereof by the computer system 200. The main memory 204 and the processor or controller 202 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for generating high resolution building databases from low resolution databases, comprising the steps of:
introducing a low resolution database;
selecting a desired area using the low resolution database;
classifying portions of the desired area and a corresponding geolocation of objects;
geographically locating the portions of the desired area;
generating a new desired area of higher resolution setting than is found on the low resolution database;
incorporating the portions of the desired area that were geographically located in the new desired area; and
replacing the portions of the desired area that were geographically located with a higher resolution object.

2. The method of claim 1, wherein the method further comprises the step of defining the low resolution database.

3. The method of claim 1, wherein the method further comprises the step of identifying the higher resolution setting.

4. The method of claim 1, wherein the method further comprises the step of saving a composite mixed resolution database and maintaining scale when replacing from low resolution to higher resolution.

5. The method of claim 1, wherein the step of classifying portions comprises classifying various classes of buildings within the desired area.

6. The method of claim 5, wherein the step of geographically locating the portions of the desired area comprises geo-locating each building within the desired area.

7. The method of claim 1, wherein the method further comprises taking an aerial image and using pixilation of the aerial image to create a higher resolution image by interpolation of one pixel to multiple pixels to form a higher resolution image.

8. The method of claim 1, wherein the method further comprises the step of using a database of existing buildings and structures to enhance a low resolution image to provide a higher resolution portion for purposes of radio frequency simulation.

9. The method of claim 1, wherein the step of incorporating the portions of the desired area that were geographically located in the new desired area comprises the step of superimposing higher resolution data onto a lower resolution data image.

10. A computer program embodied in a computer storage medium and operable in a data processing machine for generating high resolution building databases from low resolution databases improving accuracy of radio frequency coverage simulations, comprising instructions executable by the data processing machine that cause the data processing machine to:
introduce a low resolution database;
select a desired area using the low resolution database;
classify portions of the desired area;
geographically locate the portions of the desired area;
generate a new desired area based on a higher resolution setting than is found on the low resolution database;
incorporate the portions of the desired area that were geographically located in the new desired area; and
replace the portions of the desired area that were geographically located with a higher resolution object.

11. The computer program of claim 10, wherein the instructions further cause the data processing machine to define the low resolution database and identify the higher resolution setting.

12. The computer program of claim 10, wherein the instructions further cause the data processing machine to save a composite mixed resolution database.

13. The computer program of claim 10, wherein classifying portions comprises classifying various classes of buildings within the desired area and geographically locating the portions of the desired area comprises geo-locating each building within the desired area.

14. The computer program of claim 10, wherein the instructions further cause the data processing machine to process an aerial image and use pixilation of the aerial image to create a higher resolution image by interpolation of one pixel to multiple pixels to form a higher resolution image.

15. The computer program of claim 10, wherein the instructions further cause the data processing machine to use a database of existing buildings and structures to enhance a low resolution image to provide a higher resolution portion for purposes of radio frequency simulation.

16. The computer program of claim 10, wherein incorporating the portions of the desired area that were geographically located in the new desired area comprises superimposing higher resolution data onto a lower resolution data image.

17. A method for generating high resolution building databases from low resolution databases, comprising the steps of:
introducing a low resolution database and defining the resolution of the low resolution database;
selecting a desired area using the low resolution database;
classifying portions of the desired area by classifying various classes or types of buildings within the desired area;
identifying a higher resolution setting;
geographically locating the portions of the desired area;
generating a new desired area based on the higher resolution setting than is found on the low resolution database;
incorporating the portions of the desired area that were geographically located in the new desired area; and
replacing the portions of the desired area that were geographically located with a higher resolution object.

18. The method of claim 17, wherein the method further comprises the step of saving a composite mixed resolution database.

19. The method of claim 17, wherein the step of geographically locating the portions of the desired area comprises geo-locating each building within the desired area.

20. The method of claim 17, wherein the method further comprises taking an aerial image and using pixilation of the aerial image to create a higher resolution image by interpolation of one pixel to multiple pixels to form a higher resolution image.
